(19) United States
(12) Patent Application Publication
(10) Pub. No.: US 2012/0178320 A1
(43) Pub. Date: Jul. 12, 2012

(54) Method and device for providing floating system

(76) Inventor: Jack Shao-Chun Chu, Arcadia, CA (US)

(21) Appl. No.: 12/930,562

(22) Filed: Jan. 10, 2011

(51) Int. Cl. B63C 9/30; B23P 11/00

(52) U.S. Cl. 441/125; 29/428

(57) ABSTRACT

A floating device of an outdoor furniture comprises a frame, at least two floaters removably disposed on the frame, at least two connecting elements respectively disposed on surfaces of the floaters for connecting with each other to bind the floaters together to form a floating system, and at least one inserter fixed on the frame, wherein at least one of the floaters is located by the inserter to block the floaters from removing from the frame.

### BACKGROUND OF THE PRESENT INVENTION

1. Field of Invention

The present invention relates to a floating device, and more particularly to an outdoor furniture with floating device including one or more floaters and a method of binding floaters to form a floating system with predetermined pattern.

2. Description of Related Arts

On the beach, near the swimming pool or riverside, there are always chaise lounge, sofa, chair, and even bed for people to sit, to rest, to lie on enjoying the sunshine. However, these devices could only provide a simply function of resting. When the ocean wave suddenly becomes strong, or the flood comes up, or the accidents of drowning and so on happen, the life buoys and other things with floatage are always desired to save life. The beach, the swimming pool, the riverside and the like are the places with big requirements for life buoys and floating devices, if the chaise lounge, sofa, chair, or even bed used in those places could provide some floating things, like floating pads, floating cushions and the like, when an accident happens, there are a lot of usable devices to be used as life buoy, then the chance of saving life could increase. Hence, these places could become safer.

Furthermore, on the beach, people always would like to drive hydroplanes, ships and other devices, hence, some passages floating on the water are needed to provide people the approach to these places, such as the float bridge. And in the swimming pool, sometimes, people would like to play the volleyball on the water, or do other interesting game, all of which need to be processed on the water and with the floatage.

Normally these floating devices are produced with certain structures and certain functions, so they could not be used in other ways, for example, the float bridge could be used as volleyball on the water. And if there are a float bridge is not used much, it is a little waste to buy a float bridge. A better choice will be a chaise lounge, a sofa, a chair, or even a bed with floating pads, which could be composed to form a float bridge.

However, these kinds of chaise lounge, sofa, chair and bed do not exist in the market.

### SUMMARY OF THE PRESENT INVENTION

It is appreciated that the present invention provides an outdoor furniture having floating device with floaters capable of being bounded together to form a floating system.

It is appreciated that the present invention provides a floating device with frame and floaters, which could be used for resting normally and could provide floaters for saving life when accident happens.

It is appreciated that the present invention provides a floating device with frame and floaters, which could be used for resting normally and could be modified or changed into a floating system for special use.

It is appreciated that the present invention provides a floating device with multiple functions that the buyer could save money.

It is appreciated that the present invention provides a floating device with multiple functions that the user could save place.

It is appreciated that the present invention provides a method for providing a floating system that the floaters could be composed to form different floating system for different use.

The present invention provides a floating device, which comprises a frame, at least two floaters removably disposed on the frame, at least two connecting elements respectively disposed on surfaces of the floaters for connecting with each other to bind the floaters together to form a floating system, and at least one inserter fixed on the frame, wherein at least one of the floaters is located by the inserter to block the floaters from removing from the frame.

It is preferred that at least one of the floater has a hollow with a shape matched with that of the inserter, which drills through the hollow to locate the floater onto the frame and to stop other floater from removing from the frame.

It is preferred that the connecting element comprises a supporter extended along edges of surface of the floater, a plurality of fixtures fixing the supporter onto the edges of the surface of the floater, and a connecter connecting the supporter of the floater with that of adjacent floater.

Furthermore, the present invention also provides a method for providing a floating system, which comprises:

providing at least one floating device comprising at least two floaters and at least two connecting elements respectively disposed on surfaces of the floaters, wherein the connecting element comprises a supporter extended along edges of surface of the floater, a plurality of fixtures fixing the supporter onto the edges of the surface of the floater, and a connecter;

arranging the floaters in a pre-determined pattern;

connecting the supporters of adjacent floaters with the connecters.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a floating device according to a preferred embodiment of the present invention.

FIG. 2A is a partial explosive view of the floating device according to the above preferred embodiment of the present invention.

FIG. 2B is a partial explosive view of the floating device according to the above preferred embodiment of the present invention.

FIG. 3 is a perspective view of the floater according to a first preferred embodiment of the present invention.

FIG. 4A is a perspective view of the floater according to the above preferred embodiment of the present invention, illustrating the process of fixing a supporter with a fixture.

FIG. 4B is a partial explosive view of the floater according to the above preferred embodiment of the present invention, illustrating the process of fixing a supporter with a fixture.

FIG. 5A is an explosive view of the floater according to the above preferred embodiment of the present invention, illustrating the process of connecting a connecter with a supporter.

FIG. 5B is an explosive view of the floater according to the above preferred embodiment of the present invention, illustrating the process of connecting a connecter with another supporter.

FIG. 5C is a partial enlarged view of the floater according to the above preferred embodiment of the present invention, illustrating the connecting structure of the connecter and the supporter.

FIG. 6 is a perspective view of the connected floaters according to the above preferred embodiment of the present invention.

FIG. 7 is a perspective view of the floater according to the above preferred embodiment of the present invention.

FIG. 8 is a perspective view of the connected floaters according to a second preferred embodiment of the present invention.

FIG. 9A is a perspective view of the connected floaters according to a third preferred embodiment of the present invention.

FIG. 9B is a perspective view of the connecter according to the above preferred embodiment of the present invention.

FIG. 9C is a perspective view of the connecter according to the above preferred embodiment of the present invention.

FIG. 10 is a perspective view of the floating system formed by the connected floaters according to the above preferred embodiment of the present invention.

FIG. 11A is a perspective view of the connected floaters according to a fourth preferred embodiment of the present invention.

FIG. 11B is a perspective view of the connecter according to the above preferred embodiment of the present invention.

FIG. 11C is a partial enlarged view of the connecter according to the above preferred embodiment of the present invention, illustrating the connecting structure of the connecter and the supporters.

FIG. 12 is a perspective view of the floating system formed by the connected floaters according to the above preferred embodiment of the present invention.

FIG. 13A is a perspective view of the connected floaters according to a fifth preferred embodiment of the present invention.

FIG. 13B is a perspective view of the connecting elements according to the above preferred embodiment of the present invention.

FIG. 13C is a partial enlarged view of the floater according to the above preferred embodiment of the present invention, illustrating the connecting structure of the connecting elements and the floater.

FIG. 14 is a perspective view of the floating system formed by the connected floaters according to the above preferred embodiment of the present invention.

FIG. 15A is perspective view of the frame according to another preferred embodiment of the present invention.

FIG. 15B is perspective view of the frame according to another preferred embodiment of the present invention.

FIG. 15C is perspective view of the frame according to another preferred embodiment of the present invention.

FIG. 15D is perspective view of the frame according to another preferred embodiment of the present invention.

FIG. 15E is perspective view of the frame according to another preferred embodiment of the present invention.

### DETAILED DESCRIPTION OF THE PREFERRED EMBODIMENT

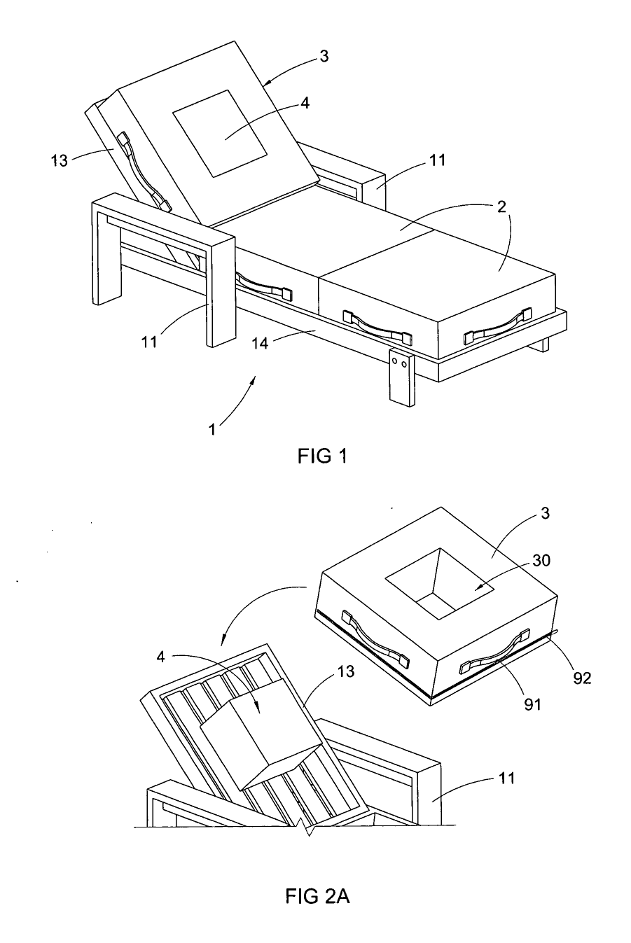

Referring to FIG. 1, the present invention discloses a floating device, which comprises:

a frame 1;

at least two floaters 2 removably disposed on the frame 1;

at least two connecting elements respectively disposed on surfaces of the floaters for connecting with each other to bind the floaters together to form a floating system; and

at least one inserter 4 fixed on the frame, wherein at least one of the floaters is located by the inserter to block the floaters from removing from the frame.

Preferred, at least one of the floaters 2 has a hollow with a shape matched with that of the inserter 4, which drills through the hollow to locate the floater onto the frame and to stop other floater from removing from the frame.

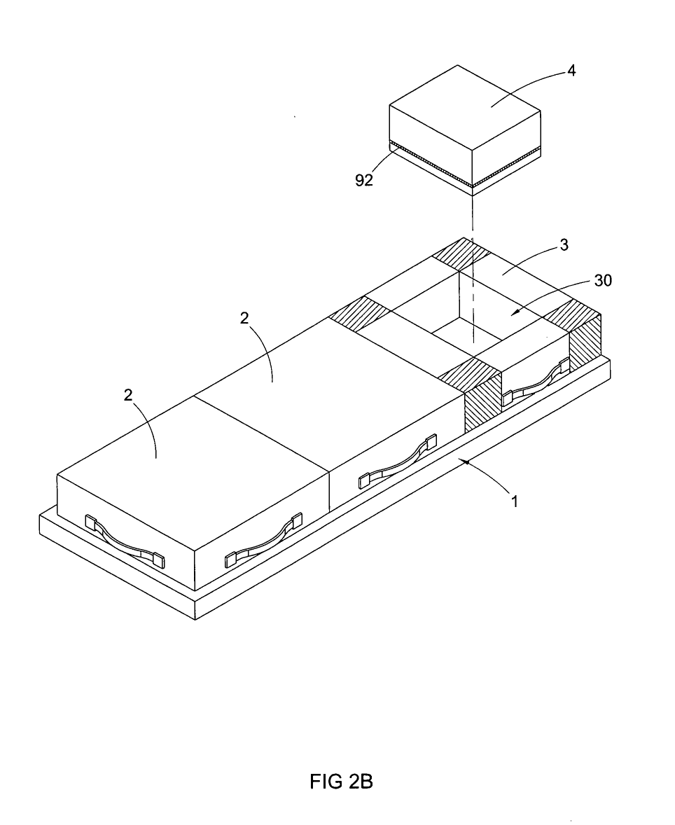

Referring to FIG. 2A, it is preferred that the floating device comprises at least two floaters 2 and at least one non-circular shaped boundary floater 3, embodied as square shape, with a hollow 30 disposed therein, wherein the hollow 30 has a shape matched with that of the inserter 4. Thereby when the inserter 4 is fixed on the frame 1, the square boundary floater 3 could be pushed down to the frame 1 with the hollow 30 drilled through by the inserter 4, resulting that the square boundary floater 3 will be located onto the frame 1. Referring to FIG. 2B, the square boundary floater 3 could also be put onto the frame 1 firstly, and then an inserter 4 could be pushed into the hollow 30 and fixed onto the frame to locate the square boundary floater 3 onto the frame 1.

Referring to FIGS. 1, 2A and 2B, when the floaters 2 are put onto the frame 1, the floaters 2 will be limited by the edges of the frame 1 instead of being tightly fastened thereon, hence these floaters 2 are removable disposed on the frame 1 that they are easily to be removed from the frame 1 to be further used as floating things. However, when the floating device is used as chaise lounge, sofa, chair or bed, these floaters 2 are needed to be located and fixed onto the frame 1 to be used as pads without self-moving off from the frame 1. Hence, after the floaters 2 are putted onto the frame 1 and limited by the edges thereof, a inserter 4 needs to be fixed or fastened onto the frame 1 and a non-circular shaped boundary floater 3, embodied as square shape, needs to be located by the inserter 4. Then as the square boundary floater 3 is located by the inserter 4, the square boundary floater 3 will not self-move off from the frame 1, and as the square boundary floater 3 and the floaters 2 are all limited by the frame 1, the floaters 2 will be blocked by the square boundary floater 3 and will not be easily to self-move off from the frame 1. Hence, the locating of the floaters 2 occurs.

At this time, the floaters 2 are tightly limited by the frame 1, so it is a little hard for people to take them out of the frame 1. Hence, the floater 2 further has at least one handle 91 disposed on the lateral surface to make the floater 2 could be easily pulled out from the frame 1. Meanwhile, the square boundary floater 3 could also has the handle 91 disposed on the lateral surface for the same use. More preferred, as the square boundary floater 3 has a hollow 30 provided therein, it could be used as a lifebelt, and meanwhile as the square boundary floater 3 has a square shape and a connecting element, it is capable of being tightly assembled with other square floaters 3 by the connecting elements to form a big floating deck, such as a floating bridge.

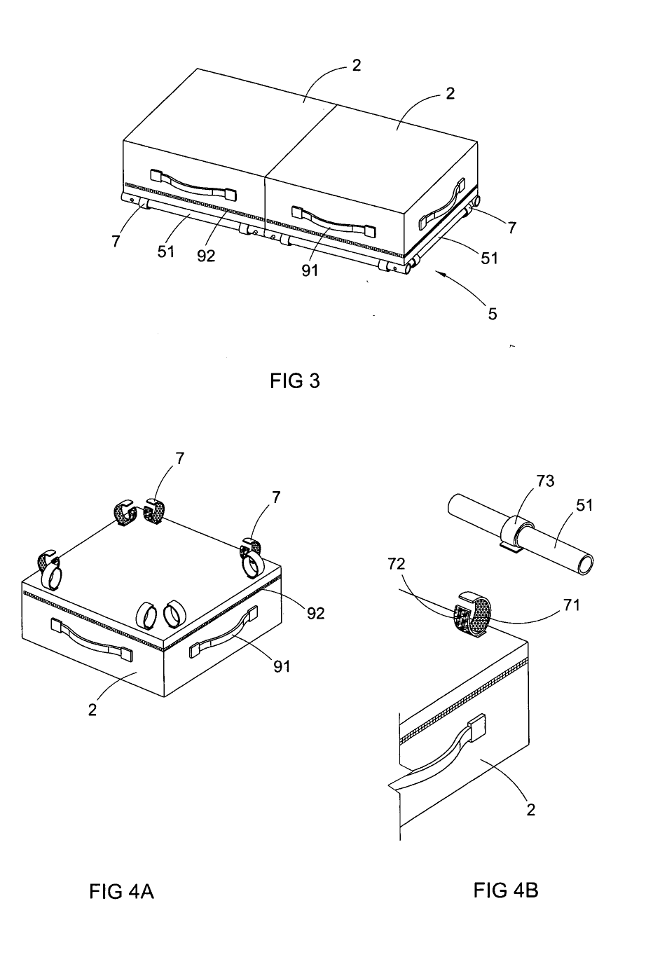

Referring to FIG. 3 and FIG. 6, the connecting element comprises a supporter 5 extended along edges of surface of the floater 2, a plurality of fixtures 7 fixing the supporter 5 onto the edges of the surface of the floater 2, and a connecter 6 connecting the supporter 5 of the floater 2 with that of adjacent floater 2.

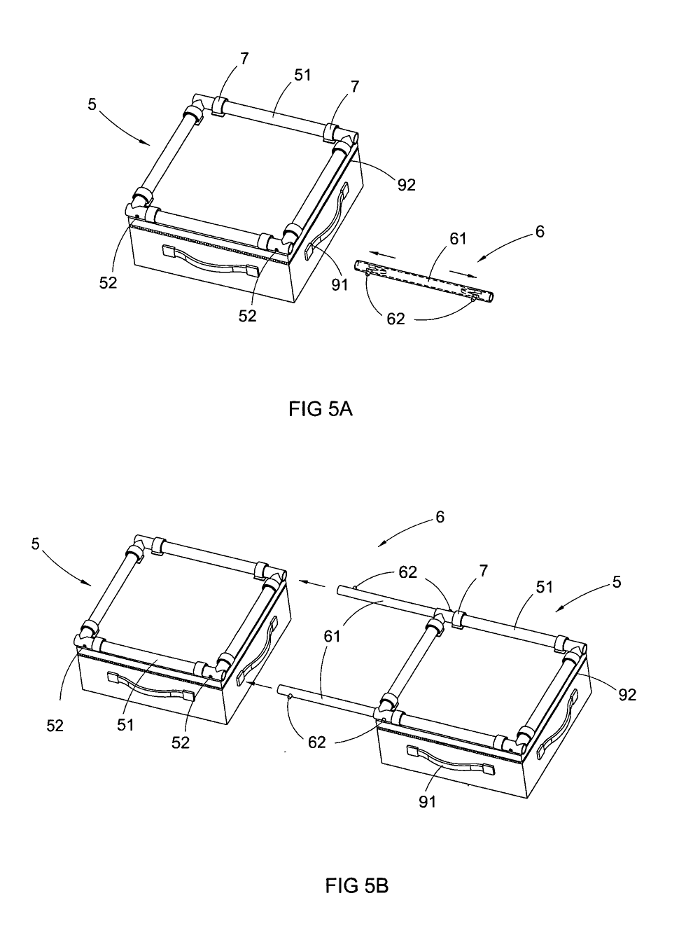

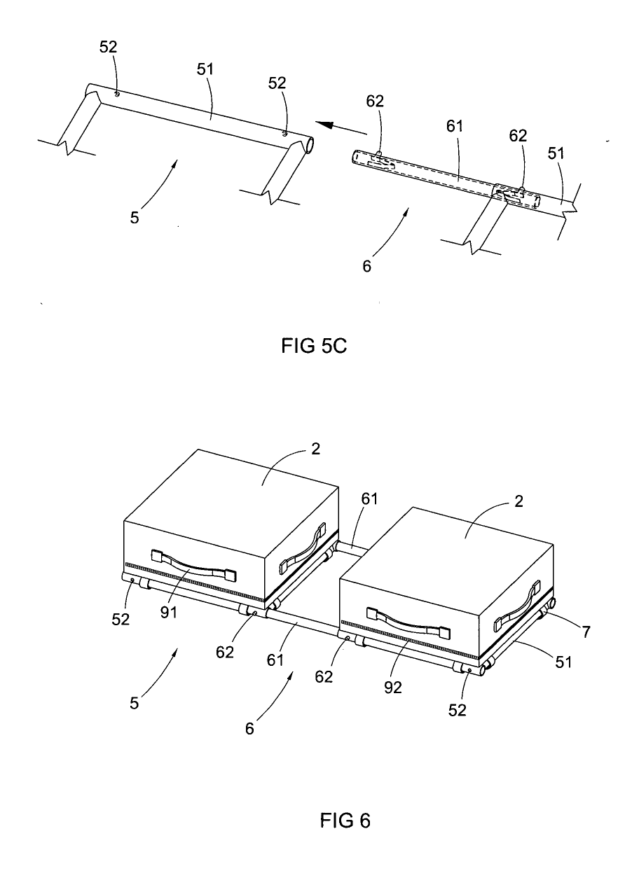

Referring to FIGS. 4A-4B and 5A-5C, it is preferred that the supporters 5 are disposed on the bottom surface of the floater 2. The supporter 5 comprises four supporting bars 51 respectively extending along and being fixed by the plurality of fixtures 7 onto four edges of the surface of the floater 2, and the four supporting bars connect with each other sequentially to form a square supporting frame fixed onto the surface of the floater 2.

Referring to FIGS. 4A-4B, the fixture 7 comprises a first adhesion surface 71, a second adhesion surface 72 and an adhesion belt 73. The second adhesion surface 72 is fixed onto the surface of the floater 2. The adhesion belt 73 surrounds the supporting bar 51 of the supporter 5 and could be adhered to the first adhesion surface 71 to fasten the supporting bar 51 of the supporter 5 with the fixture 7. Furthermore, the first adhesion to surface of one end of the fixture 7 is adhered to the second adhesion surface of the other end of the fixture 7 to form a ring with the first adhesion surface as inner surface, which is adhered to the adhesion belt to fix the supporting bar 51 with the fixture, thereby the supporter is fixed onto the floater by the fixtures.

When using, firstly surrounds the supporting bar 51 of the supporter 5 with the second adhesion surface 72 to make the adhesion belt 73 adhered to the second adhesion surface 72, and then adhere the first adhesion surface 71 of one end of the fixture 7 to the second adhesion surface 72 of the other end of the fixture 7 to form a ring which further limits and locates the supporting bar 51 of the supporter 5. Thereby, the supporting bar 51 of the supporter 5 is fixed onto the floater 2 by the fixtures 7.

It is preferred that the supporting bar 51 is fixed onto the floater by at least two fixtures.

Here, a floater 2 with the supporter 5 fixed thereon by the fixtures 7 is obtained as shown in FIG. 5A. It is preferred that the supporting bar 51 of the supporter 5 has two connecting holes 52 disposed on two ends thereof and the connecter 6 comprises a connecting bar 61 and two connecting plugs 62 disposed on two ends thereof. Referring to FIG. 5C, the connecting bar 61 has a smaller diameter than that of the supporting bar 51, and one end of the connecting bar 61 could be pushed into cavity of one end of the supporting bar 51, and then the plug 62 disposed on the end of the connecting bar 61 will plug into the connecting hole 52 disposed on the end of the supporting bar 51, thereby the connecter 6 is connected to the supporter 5.

Referring to FIG. 5C, it is preferred that the connecting bar 61 further has two holes 63 disposed on the two ends and the connecting plug 62 has a plug 621 drilled through the hole 63 and an elastic element 622 connected with the plug 621 and disposed inside of the connecting bar 61. When the connecting plug 62 is being pressed, the plug 621 will further press the elastic element 622, which subsequently contracts to permit the plug 621 to be pushed into the cavity of the connecting bar 61. When the connecting plug 62 is released from the pressure, the elastic element 622 stretches to force the plug 621 drill out off the hole 63 to provide a plugging function.

Referring to FIG. 5C, when the connecting bar 61 is pushed into the supporting bar 51, the connecting plug is forced by the sidewall of the supporting bar 51 to move into the cavity of the connecting bar 61, thereby the connecting bar 61 could be smoothly inserted into the cavity of the supporting bar 51 to reach a position that the connecting plug 62 and the connecting hole 52 are overlapped, then the connecting plug 62 is released from being pressed by the sidewall of the connecting bar 51 and will stretch to plug into the connecting hole 52, resulting that the connecting bar 61 and the supporting bar 51 are connected together.

Referring to FIGS. 5A and 5B, firstly insert one end of a connecter 6 into one end of a supporting bar 51 of a supporter 5 of a floater 2 to connect the supporter 5 to the connecter 6, then insert another end the connecter 6 into one end of a supporting bar 51 of a supporter 5 of another floater 2 to connect this supporter 5 to the connecter 6, thereby the first floater 2 is connected with the second floater 2 by the connecter 6.

Referring to FIG. 6, the supporter 5 of the floater 2 is connected with that of other floaters 5 by the connecter 6 to bind at least two floaters 2 together to form a floating system. In this floating system, the floaters 2 could be connected one by one to extend along the water and form a desired pattern, such as a road on the water, a bridge on the water, or even a ground on the water. [symbol] preferred that the floater 2 has a case, preferred waterproof case, which could be opened by a slide fastener 92 disposed thereon, then a floatable body 8 could be filled into the cavity of the case to provide the required floatage, as illustrated in FIG. 7, thereby the floaters 2 could be assembled together with or without a frame to provide enough floatage to permit the users to sit, to lay or to stand thereon.

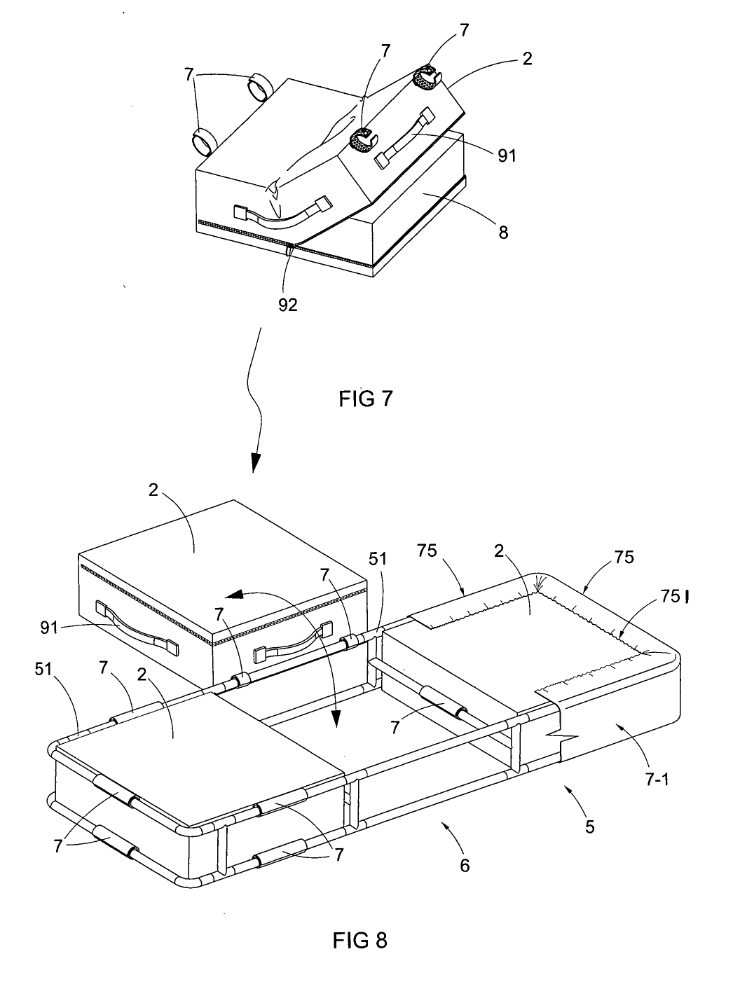

FIG. 8 illustrates another preferred embodiment of the floater 2. In order to fasten two or more floaters 2 together, the floater 2 could has two supporters 5 affixed on the top surface and on the bottom surface, wherein the two supporters 5 are respectively connected with two supporters 5 of another floater 2 by at the connecters 6 to bind the floaters 2 together. Furthermore, the fixture 7 further comprises a waterproof fabric made cover 7-1 covering the floaters 2 and the supporters 5, wherein the cover 7-1 having a surrounding edge portion 75 surrounding the supporters 5 on the top surface and the supporter 5 on the bottom surface to enclose or limit respective floater 2 therein and an elastic element 751 provided around the surrounding edge portion 75 for mounting and holding the cover 7-1 in position. As a result, the floaters 2 could be better connected to the supporters 5 to provide an assemble of floaters 2 strong enough to be used as a bed cushion.

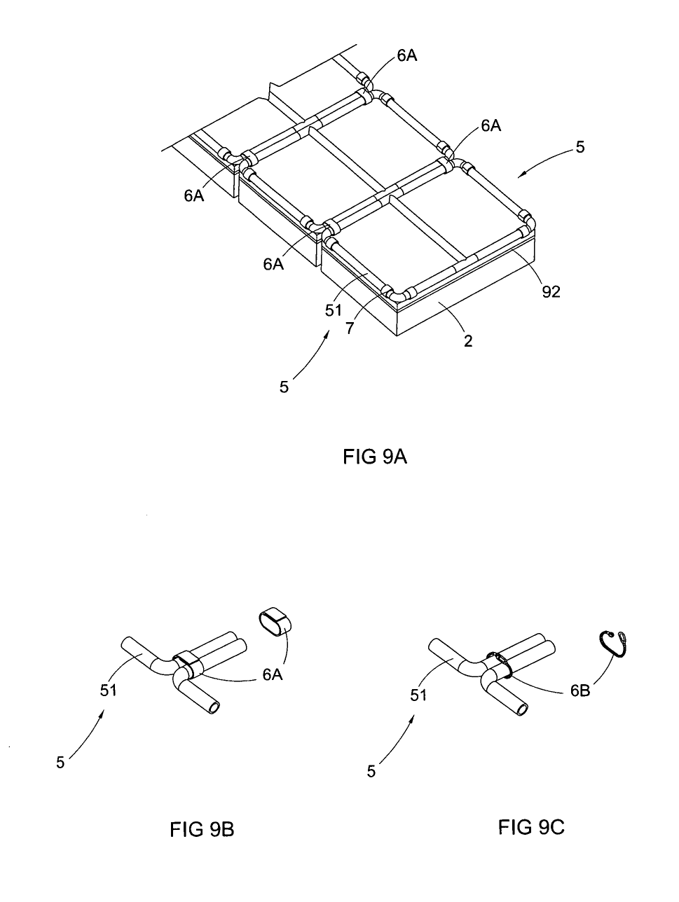

FIG. 9A illustrates another preferred embodiment of the floater 2. The supporter 5 is a bar ring extended along edges of surface of the floater 2, the connecter 6 is a connecting ring surrounding the supporting bars 51 of the supporters 5 of adjacent two floaters 2 to connect the supporters 5 with each other, thereby the two floaters 2 are bound together.

Referring to FIG. 9A, the floaters 2 are square and are arranged in such a manner that adjacent floaters 2 are contacted with each other that the adjacent edges are parallel and contacted. Then the supporter 5 is square, as the supporter 5 extends along the edges of the floater 2, the supporters 5 of adjacent two floaters 2 are arranged with adjacent edges parallel and connected. Then at least two connecters 6 will be used to surround the adjacent supporting bars 51 of the adjacent two supporters 5, thereby the adjacent two floaters are bounded together with edges parallelly connected with each other. [symbol] adjacent supporting bars 51 of the adjacent two supporters 5, thereby the adjacent two floaters are bounded together with edges parallelly connected with each other.

Referring to FIG. 9B, the connecter 6 is a connecting ring with one end removable adhered to the other end, such as a belt 6A, wherein the ring 6A could surround the two adjacent supporters 5 and then self-adhere one end with the other end to form a circle tightly surrounding the supporters 5, thereby that the supporters 5 are bounded.

Referring to FIG. 9C, the connecter 6 is a connecting ring with one end removable locked with the other end, such as a ring 6B with a loop on one end and a hook on the other end, wherein the ring 6B could surround the two adjacent supporters 5 and then self-lock the loop with the hook to form a circle tightly surrounding the supporters 5, thereby the supporters 5 are bounded.

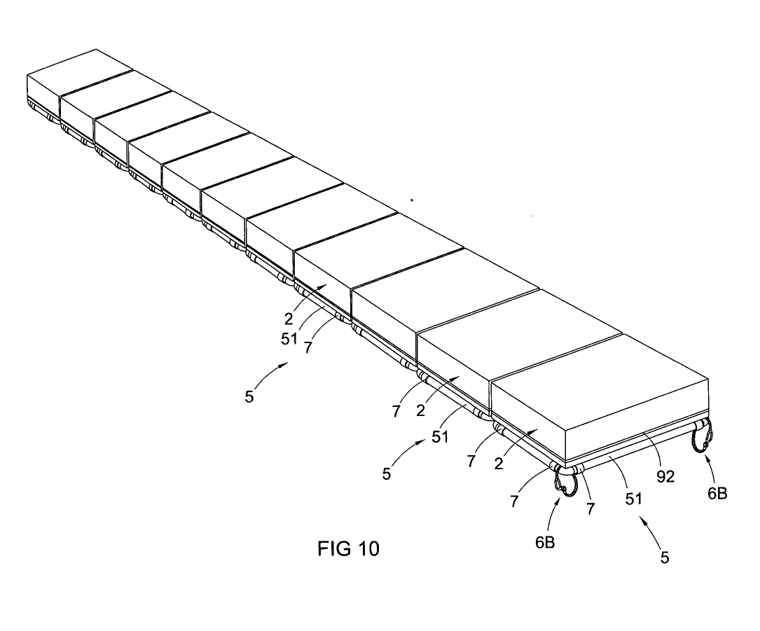

When the floaters 2 are arranged contacted with each other and are bounded with the connecter 6, a floating system as illustrated in FIG. 10 will be obtained, which could be used as a passage on water, such as a floating bridge, or be used as a float board or a floating bed on the water, and even be used in the swimming pool as a block, which could be jumped over to provide a new game of jump style swimming like dolphin.

It is preferred that the supporter 5 is fixed onto the floater 2 by at least four fixtures 7.

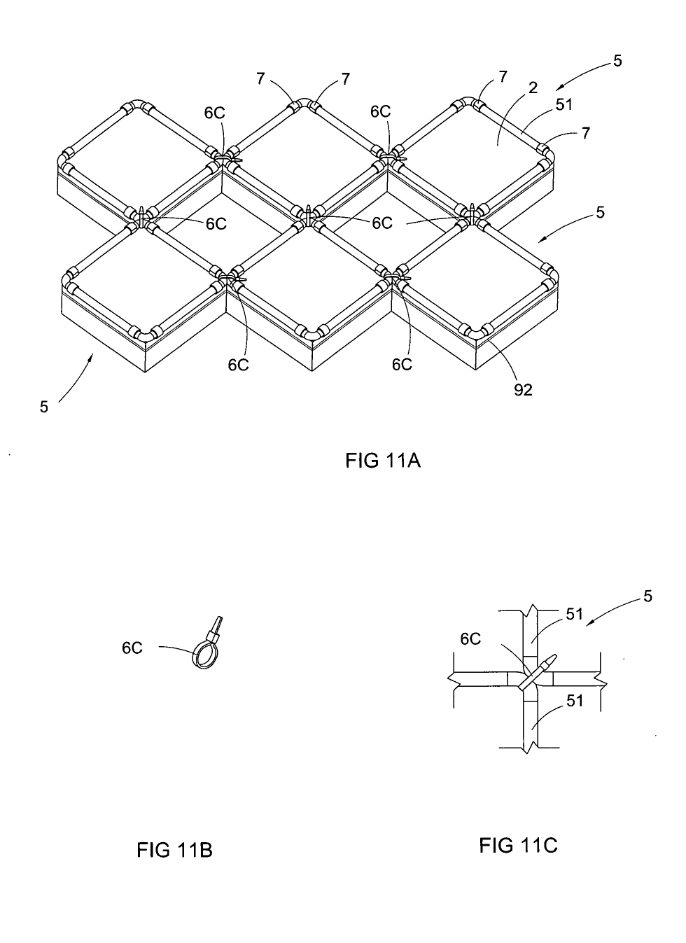

Referring to FIGS. 11A to 11C, the floaters 2 are in non-circular shape, embodied as a square shape, and are arranged with apex angles oppositely contacted with each other. Then the supporter 5 is in non-circular shape, embodied as a square shape, as the supporter 5 extends along the edges of the floater 2, the supporters 5 of adjacent two floaters 2 are arranged with adjacent apex angles opposite and connected. Hence, the connecters 6 could be used on the apex angle portion to bind the adjacent supporters 5 together.

In order to bind the floaters 2 together in the apex angle portion, it is preferred that the connecter 6 is a connecting ring with one end removable fixed with the other end, such as the fixing ring 6C as illustrated in FIG. 11B. The fixing ring 6C has a ring and a clip disposed thereon, wherein the ring could surround the two adjacent supporters 5 and then the two ends of the ring is self-fixed together by the clip to form a circle tightly surrounding the supporters 5, thereby the supporters 5 are bounded.

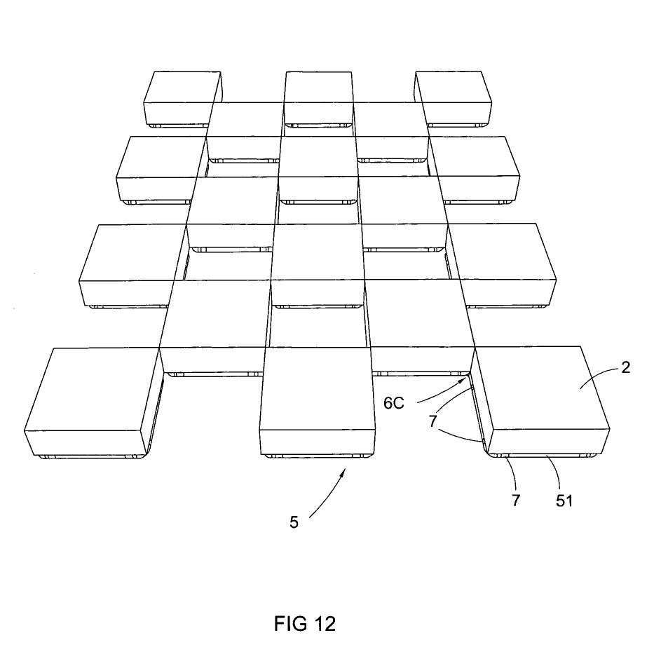

When the floaters 2 are arranged with apex angles contacted with each other and are bounded with the connecters 6, a floating system as illustrated in FIG. 12 will be obtained, which could be used as a ground on the water for playing games thereon, or be used as a stage for playing the ballet or other performances.

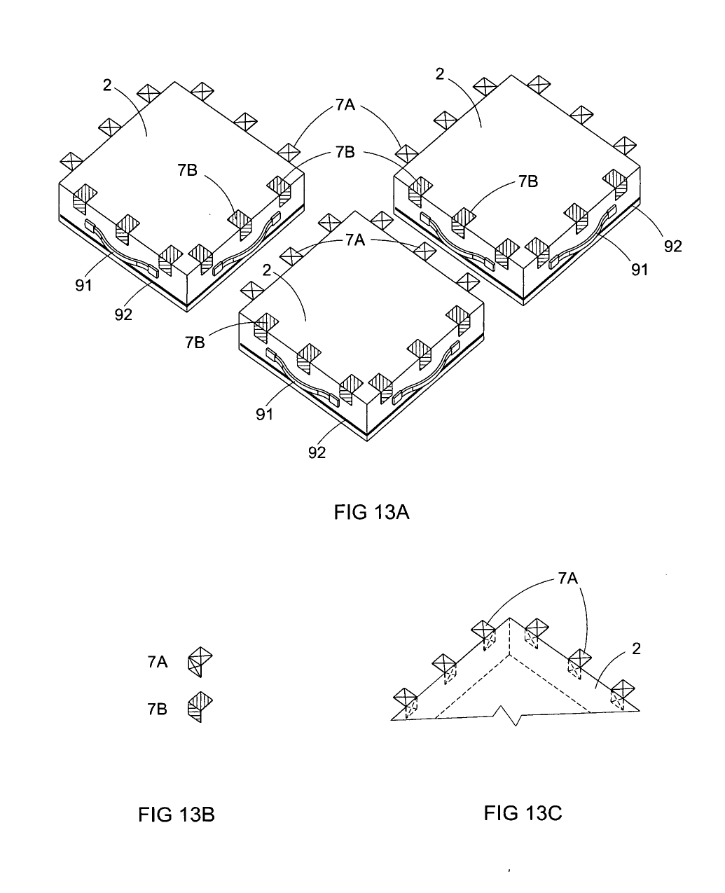

Referring to FIGS. 13A to 13C, the connecting element further comprises a plurality of first connecting elements 7A and a plurality of second connecting elements 7B disposed on the surface of the floater 2, wherein the plurality of first connecting elements 7A of one floater 2 are respectively connected with the plurality of second connecting elements 7B of adjacent floater 2 to bind the two floaters 2 together.

It is preferred that the floater 2 is in non-circular shape, embodied as a square shape, with two adjacent edges disposed with the first connecting elements 7A and another two adjacent edges disposed with the second connecting elements 7B. The plurality of first connecting elements 7A of one floater 2 is respectively connected with the plurality of second connecting elements 7B of adjacent floater 2 to bind the two floaters 2 together.

It is preferred that the floaters 2 are arranged in such a manner that adjacent edges of the adjacent floaters respectively have the first connecting elements 7A and the second connecting elements 7B disposed thereon that the adjacent edges could be connected with each other to bind the floaters 2 together.

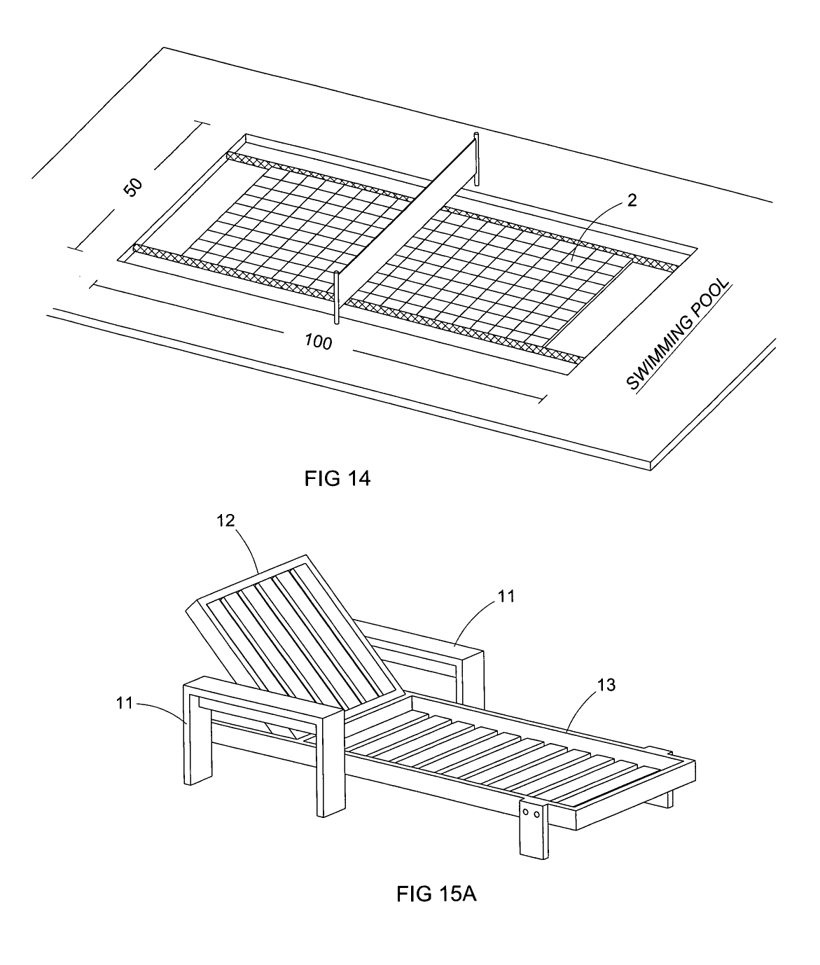

The first connecting elements 7A and the second connecting elements 7B could be used alone to bind the floaters together. Alternatively, The first connecting elements 7A and the second connecting elements 7B could be used together with the connecting elements and connecting means mentioned above to further bind the floaters 2 more tightly. This is very important when the floating system formed by the floaters 2 is used as a volleyball court or a badminton court on the water or in the swimming pool, as illustrated in FIG. 14.

It is preferred that the floating device could be used as chaise lounge, sofa, chair or bed, especially used on the beach or near the swimming pool. Hence, the frame 1 comprises at least one main body frame with the floaters 2 disposed thereon and at least two support legs 11 supporting the main body frame.

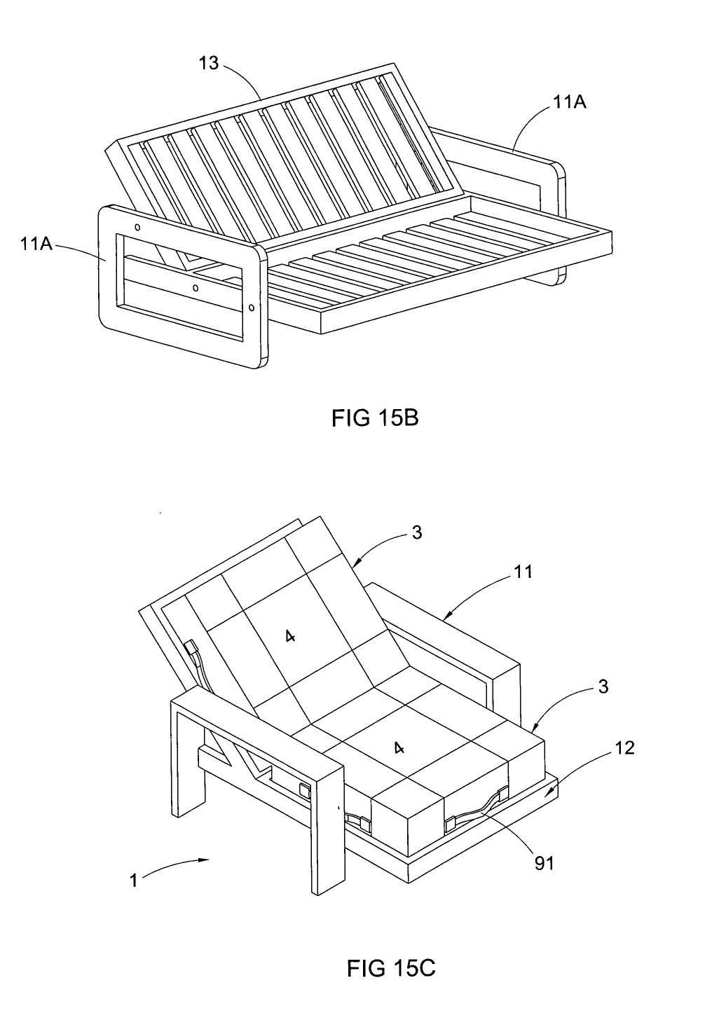

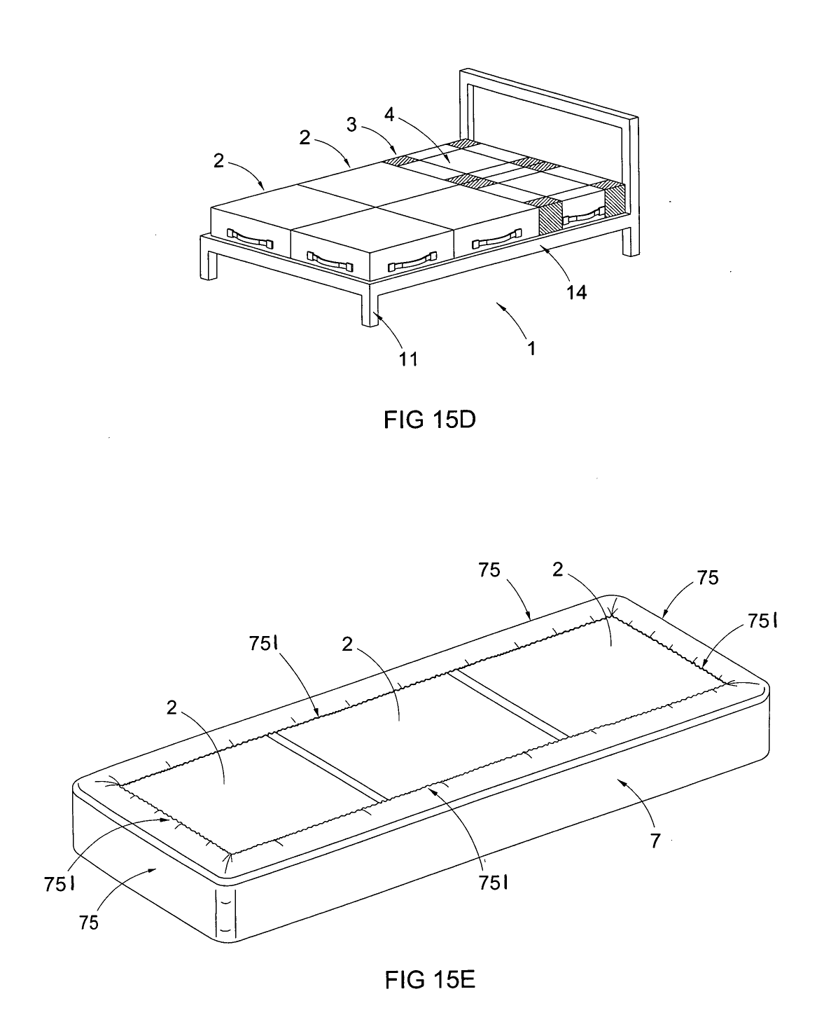

Referring to FIG. 15A, when the floating device is designed as a chaise lounge, the frame 1 comprises two support legs 11, a short main body frame 12 and a long main body frame 13, wherein the short main body frame 12 and the long main body frame 13 are connected with each other and are supported by the support legs 11. Two or more floaters 2 could be disposed on the long main body frame 13 and be used as pads, and a non-circular boundary floater 3 and an inserter 4 could be affixed on the short main body frame 13 to block the floaters 2 from removing from the frame.

Referring to FIG. 15B, when the floating device is designed as a sofa, the frame 1 comprises two support legs 11 and two long main body frames 13 connected with each other and supported by the support legs 11. Two or more floaters 2 could be disposed on the long main body frame 13 and be used as pads.

Referring to FIG. 15C, when the floating device is designed as a chair, the frame 1 comprises two support legs 11 and two short main body frames 12 connected with each other and supported by the support legs 11. A non-circular boundary floater 3 and an inserter 4 could be fixed on the short main body frame 13 and be used as pads.

Referring to FIG. 15D, when the floating device is designed as a bed, the frame 1 comprises four support legs 11 and one wide main body frames 14 supported by the support legs 11. At least two floaters 2, at least one non-circular shaped boundary floater 3, embodied as a square shape, and at least one inserter 4 could be disposed on the wide main body frames 14 and be used as mattress.

In order to provide a strong enough bed as illustrated in FIG. 15D, the floaters 2, as well as the non-circular boundary floater 3 and the inserter 4, could be connected with each other by the supporters as illustrated in FIG. 8, resulting that the floaters 2, the non-circular boundary floater 3 and the inserter 4 have been affixed both on the top surfaces and on the bottom surfaces and then have been limited by the elastic elements 751. Hence, the floaters 2, the boundary floater 3 and the inserter 4 could be tightly connected with each other to form a bed cushion, which is used on the frame 1 as illustrated in FIG. 15D.

As mentioned above, the floating devices as illustrated in FIGS. 15A-15E could be used as normal fitments in the house, near the swimming pool, on the beach or in the other suitable places. However, the floaters 2 of these floating devices could be removed off to be further connected together as mentioned above to form a floating system according to the requirements. And the square floaters 3 of these floating devices could also be removed off to be used as lifebelts for saving people.

It is preferred that the locator 4 is a floater having the same structures of the floater 2, but with a smaller size. Thereby the inserter 4 could also be used to provide floatage and be used as pad.

The present invention also discloses a method for providing a floating system, which comprises the steps of:

providing at least one floating device comprising at least two floaters 2 and at least two connecting elements respectively disposed on surfaces of the floaters 2, wherein the connecting element comprises a supporter 5 extended along edges of surface of the floater 2, a plurality of fixtures 7 fixing the supporter 5 onto the edges of the surface of the floater 2, and a connecter 6;

It is preferred that the floaters 2 are arranged parallel with each other and with a certain distance between each other, as illustrated in FIGS. 6 and 8.

It is preferred that the supporter 5 comprises four supporting bars respectively extending along and being fixed by the plurality of fixtures 7 onto four edges of the surface of the floater 2.

It is preferred that the supporting bar 51 has two connecting holes 52 disposed on two ends thereof and the connecter 6 comprises a connecting bar 61 and two connecting plugs 62 disposed on two ends thereof, wherein the connecting bar 61 has a smaller diameter than that of the supporting bar 51.

It is preferred that the step of connecting the supporters 5 of adjacent floaters 2 with the connecters 6 further comprises the steps of:

pushing one end of the connecting bar 61 into cavity of one end of a supporting bar 51 of a floater 2 to let the connecting plug 62 disposed on the end of the connecting bar 61 plug into the connecting hole 52 disposed on the end of the supporting bar 51;

pushing another end of the connecting bar 61 into cavity of one end of another supporting bar 51 of adjacent floater 2 to let the plug 62 disposed on the end of the connecting bar 61 plug into the connecting hole 52 disposed on the end of the supporting bar 51; and

repeating connecting step to bind adjacent floaters 2 with each other.

Referring to FIGS. 9A to 9C, in another preferred embodiment, the floaters 2 are arranged parallel with each other and contacted with each other. The supporter 5 is a bar ring extended along edges of surface of the floater 2, the connecter 6 is a connecting ring 61 surrounding bars of the supporters 5 of adjacent two floaters 2 to connect the supporters 5 with each other, and thereby the two floaters 2 are bound together, wherein the supporter 5 is in non-circular shape, embodied as a square shape.

It is preferred that the step of connecting the supporters 5 of adjacent floaters 2 with the connecters 6 further comprises the steps of:

arranging the supporters 5 of adjacent two floaters 2 with adjacent edges parallel and contacted;

surrounding the supporters 5 with at least two connecters 6 on parallel portion; and

repeating connecting step to bind adjacent floaters 2 with each other.

The connecter 6 is a connecting ring with one end removable adhered to the other end, or a connecting ring with one end removable locked with the other end, or a connecting ring with one end removable fixed with the other end.

Referring to FIGS. 11A to 11C, in another preferred embodiment, the floaters 2 are arranged with adjacent apex angles opposite and contacted with each other. The supporter 5 is a bar ring extended along edges of surface of the floater 2, the connecter 6 is a connecting ring surrounding bars of the supporters 5 of adjacent two floaters 2 to connect the supporters 5 with each other, and thereby the two floaters 2 are bound together, wherein the supporter 5 is in non-circular shape, embodied as a square shape.

It is preferred that the step of connecting the supporters 5 of adjacent floaters 2 with the connecters 6 further comprises the steps of:

arranging the supporters 5 of adjacent two floaters 2 with adjacent apex angles opposite and contacted;

surrounding the supporters 5 with at least two connecters 6 on the contacted apex angles portion; and

repeating connecting step to bind adjacent floaters 2 with each other.

surrounding the supporters 5 with at least two connecters 6 on the contacted apex angles portion; and

repeating connecting step to bind adjacent floaters 2 with each other.

The connecter 6 is a connecting ring with one end removable adhered to the other end, or a connecting ring with one end removable locked with the other end, or a connecting ring with one end removable fixed with the other end.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A floating device, comprising:
a frame;
at least two floaters removably disposed on said frame;
at least two connecting elements respectively disposed on surfaces of said floaters for connecting with each other to bind said floaters together to form a floating system; and
at least one inserter fixed on said frame, wherein at least one of said floaters is located by said inserter to block said floaters from removing from said frame.

2. The floating device, as recited in claim 1, wherein at least one of said floater has a hollow with a shape matched with that of said inserter, which drills through said hollow to locate said floater onto said frame and to stop other floater from removing from said frame.

3. The floating device, as recited in claim 1, wherein said connecting element comprises a supporter extended along edges of surface of said floater, a plurality of fixtures fixing said supporter onto said edges of said surface of said floater, and a connecter connecting said supporter of said floater with that of adjacent floater.

4. The floating device, as recited in claim 3, wherein said supporter comprises four supporting bars respectively extending along and being fixed by said plurality of fixtures onto four edges of said surface of said floater, wherein said four supporting bars connect with each other sequentially to form a non-circular shaped supporting frame fixed onto said surface of said floater.

5. The floating device, as recited in claim 4, wherein said supporting bar has two connecting holes disposed on two ends thereof and said connecter comprises a connecting bar and two connecting plugs disposed on two ends thereof,
wherein said connecting bar has a smaller diameter than that of said supporting bar, and one end of said connecting bar could be pushed into cavity of one end of said supporting bar to let said plug disposed on said end of said connecting bar plug into said connecting hole disposed on said end of said supporting bar, whereby said connecter is connected to said supporter.

6. The floating device, as recited in claim 5, wherein said supporter of said floater is connected with that of other floaters by said connecter to bind at least two floaters together to form a floating system.

7. The floating device, as recited in claim 6, wherein said fixture comprises a first adhesion surface, a second adhesion surface fixed onto said surface of said floater, and an adhesion belt surrounding said supporting bar of said supporter,
wherein said first adhesion surface of one end of said fixture is adhered to said second adhesion surface of the other end of said fixture to form a ring with said first adhesion surface as inner surface, which is adhered to said adhesion belt to fix said supporting bar with said fixture, whereby said supporter is fixed onto said floater by said fixtures.

8. The floating device, as recited in claim 7, wherein said supporting bar is fixed onto said floater by at least two fixtures.

9. The floating device, as recited in claim 8, wherein said floater comprises a floatable body providing floatage, a case covered thereon, and a handle disposed on said case.

10. The floating device, as recited in claim 7, wherein said floater has two supporters fixed on top surface and on bottom surface, wherein said two supporters are respectively connected with those two of another floater by said connecters to bind said floaters together.

11. The floating device, as recited in claim 10, wherein said floater comprises a floatable body providing floatage, a case covered thereon, and a handle disposed on said case.

12. The floating device, as recited in claim 3, wherein said supporter is a bar ring extended along edges of surface of said floater, said connecter is a connecting ring surrounding bars of said supporters of adjacent two floaters to connect said supporters with each other, whereby said two floaters are bound together.

13. The floating device, as recited in claim 12, wherein said fixture comprises a first adhesion surface, a second adhesion surface fixed onto said surface of said floater, and an adhesion belt surrounding said pipe of said supporter, wherein said first adhesion surface of one end of said fixture is adhered to said second adhesion surface of the other end of said fixture to form a ring with said first adhesion surface as inner surface, which is adhered to said adhesion belt to fix said pipe with said fixture, whereby said supporter is fixed onto said floater by said fixtures.

14. The floating device, as recited in claim 13, wherein said supporter is fixed onto said floater by at least four fixtures.

15. The floating device, as recited in claim 13, wherein said connecter is a connecting ring with one end removable adhered to the other end.

16. The floating device, as recited in claim 13, wherein said supporter is in non-circular shape, said supporters, adjacent two floaters, are arranged with adjacent edges parallel and connected, and surrounded by at least two connecters, whereby said adjacent two floaters are bounded together with edges parallelly connected with each other.

17. The floating device, as recited in claim 16, wherein said floater comprises a floatable body providing floatage, a case covered thereon, and a handle disposed on said case.

18. The floating device, as recited in claim 13, wherein said supporter is in non-circular shape, said supporters, adjacent two floaters, are arranged with adjacent apex angles opposite and connected, and surrounded by one connecter, whereby said adjacent two floaters are bounded together with apex angles oppositely connected with each other.

19. The floating device, as recited in claim 18, wherein said floater comprises a floatable body providing floatage, a case covered thereon, and a handle disposed on said case.

20. The floating device, as recited in claim 1, wherein said connecting element comprises a plurality of first connecting elements and a plurality of second connecting elements, wherein said plurality of first connecting elements of one floater is respectively connected with said plurality of second connecting elements of adjacent floater to bind said two floaters together.

21. The floating device, as recited in claim 19, wherein said floater is in non-circular shape with two adjacent edges disposed with said first connecting elements and another two adjacent edges disposed with said second connecting elements, wherein said floaters are arranged in such a manner that adjacent edges of said floaters respectively have said first connecting elements and said second connecting elements disposed thereon that said adjacent edges are connected with each other that said floaters are bounded together.

22. The floating device, as recited in claim 3, wherein said frame comprises at least one main body frame with said floaters disposed thereon and at least two support legs supporting said main body frame.

23. The floating device, as recited in claim 22, wherein said frame is chaise lounge shape, sofa shape, chair shape or bed shape.

24. A method for providing a floating system comprising the steps of:
providing at least one floating device comprising at least two floaters and at least two connecting elements respectively disposed on surfaces of said floaters, wherein said connecting element comprises a supporter extended along edges of surface of said floater, a plurality of fixtures fixing said supporter onto said edges of said surface of said floater, and a connecter;
arranging said floaters in a pre-determined pattern; and
connecting said supporters of adjacent floaters with said connecters.

25. The method, as recited in claim 24, wherein said floaters are arranged parallel with each other with a certain distance between each other.

26. The method, as recited in claim 25, wherein said supporter comprises four supporting bars respectively extending along and being fixed by said plurality of fixtures onto four edges of said surface of said floater.

27. The method, as recited in claim 26, wherein said supporting bar has two connecting holes disposed on two ends thereof and said connecter comprises a connecting bar and two connecting plugs disposed on two ends thereof, wherein said connecting bar has a smaller diameter than that of said supporting bar.

28. The method, as recited in claim 27, wherein said step of connecting said supporters of adjacent floaters with said connecters further comprises the steps of:
pushing one end of said connecting bar into cavity of one end of a supporting bar of a floater to let said plug disposed on said end of said connecting bar plug into said connecting hole disposed on said end of said supporting bar;
pushing another end of said connecting bar into cavity of one end of another supporting bar of adjacent floater to let said plug disposed on said end of said connecting bar plug into said connecting hole disposed on said end of said supporting bar; and
repeating said connecting step to bind adjacent floaters with each other.

29. The method, as recited in claim 24, wherein said floaters are arranged parallel with each other and contacted with each other.

30. The method, as recited in claim 29, wherein said supporter is a pipe ring extended along edges of surface of said floater, said connecter is a connecting ring surrounding bars of said supporters of adjacent two floaters to connect said supporters with each other, whereby said two floaters are bound together, wherein said supporter is in non-circular shape.

31. The method, as recited in claim 30, wherein said step of connecting said supporters of adjacent floaters with said connecters further comprises the steps of:
arranging said supporters of adjacent two floaters with adjacent edges parallel and contacted;
surrounding said supporters with at least two connecters on parallel portion; and
repeating said connecting step to bind adjacent floaters with each other.

32. The method, as recited in claim 31, wherein said connecter is a selected from a group consisting of a connecting ring with one end removable adhered to the other end, a connecting ring with one end removable locked with the other end, and a connecting ring with one end removable fixed with the other end.

33. The method, as recited in claim 24, wherein said floaters are arranged with adjacent apex angles opposite and contacted with each other.

34. The method, as recited in claim 33 wherein said supporter is a pipe ring extended along edges of surface of said floater, said connecter is a connecting ring surrounding bars of said supporters of adjacent two floaters to connect said supporters with each other, whereby said two floaters are bound together, wherein said supporter is in non-circular shape.
